(19) United States
(12) Patent Application Publication
(10) Pub. No.: US 2019/0306357 A1
(43) Pub. Date: Oct. 3, 2019

(54) IMAGE PROCESSING APPARATUS AND CONTROL METHOD

(71) Applicants: KABUSHIKI KAISHA TOSHIBA, Tokyo (JP); TOSHIBA TEC KABUSHIKI KAISHA, Tokyo (JP)

(72) Inventor: Naoya KOSEKI, Sunto Shizuoka (JP)

(21) Appl. No.: 15/941,671

(22) Filed: Mar. 30, 2018

(51) Int. Cl. H04N 1/00; H04N 1/10; G06F 3/12

(52) U.S. Cl. CPC H04N 1/00737; H04N 1/00742; G06F 3/1279; H04N 1/1061

(57) ABSTRACT

In accordance with an embodiment, an image processing apparatus comprises a platen cover, a detector, and a controller. The platen cover is attached to an upper surface of a platen glass in an openable manner. The detector at a lower surface side of the platen glass, is configured to detect an object on the upper surface of the platen glass. The controller is configured to determine an elapsed time from when the object is detected by the detector to when the platen cover goes into a predetermined state, and to determine a sheet size of the object according to a first technique if the elapsed time is less than a threshold time and according to a second technique if the elapsed time is greater than the threshold time.

### FIELD

Embodiments described herein relate generally to an image processing apparatus and a control method.

### BACKGROUND

A conventional image processing apparatus includes a platen glass on which a document to be scanned is placed and a platen cover mounted on an upper surface thereof in an openable manner. In such an image processing apparatus, a size of a sheet placed on the platen glass is automatically detected by a sensor.

In some cases, slackness occurs in the platen cover due to deterioration from aging. In this case, the slackness may approach or contact the platen glass while the platen cover is closed, and may be erroneously detected as the sheet.

### DESCRIPTION OF THE DRAWINGS

FIG. 1 is an external view of an image processing apparatus according to an embodiment;

FIG. 2 is a diagram illustrating a control system of the image processing apparatus;

FIG. 3 is a diagram illustrating the configuration of a reading device viewed from the front of the image processing apparatus;

FIG. 4 is a diagram illustrating the configuration of the reading device viewed from the side of the image processing apparatus;

FIGS. 5-7 are diagrams illustrating a detection timing of a sheet sensor and an open/close detection sensor;

FIG. 8 is a flowchart depicting the flow of a size specifying process;

FIG. 9 illustrates a screen for allowing a user to select a sheet size; and

FIG. 10 illustrates a screen for allowing the user to confirm the sheet size.

### DETAILED DESCRIPTION

In accordance with an embodiment, an image processing apparatus comprises a platen cover, a detector, and a controller. The platen cover is attached to an upper surface of a platen glass in an openable manner. The detector at a lower surface side of the platen glass, is configured to detect an object on the upper surface of the platen glass. The controller is configured to determine an elapsed time from when the object is detected by the detector to when the platen cover goes into a predetermined state, and to determine a sheet size of the object according to a first technique if the elapsed time is less than a threshold time and according to a second technique if the elapsed time is greater than the threshold time.

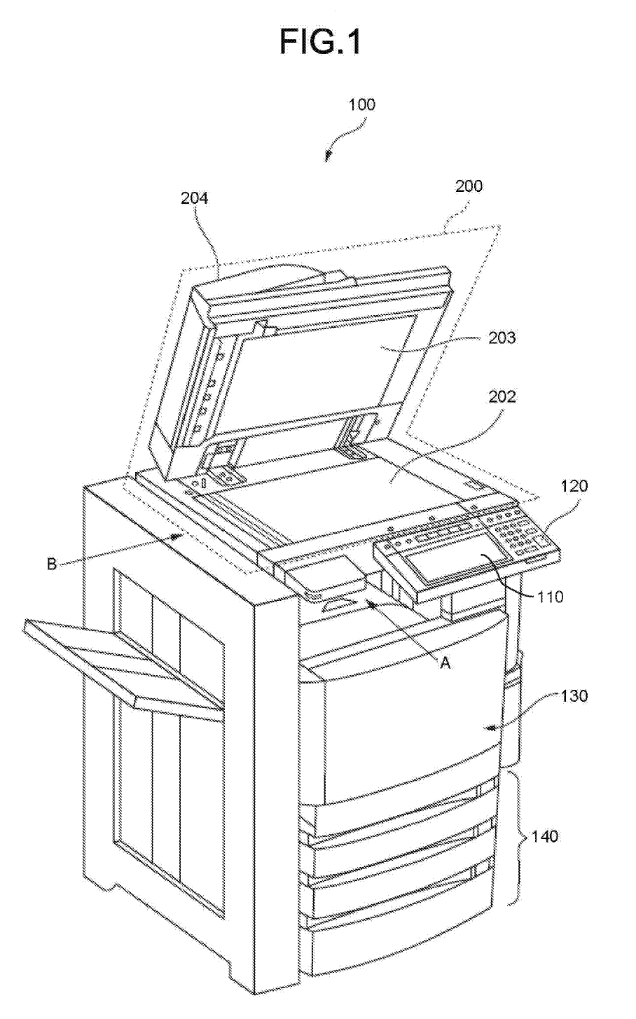

FIG. 1 is an external view of an image processing apparatus 100 according to the embodiment. The image processing apparatus 100 is, for example, a multi-functional peripheral. The image processing apparatus 100 includes a display 110, a control panel 120, a printer section 130, a sheet housing section 140, and an image reading section 200.

The image processing apparatus 100 forms an image on a sheet using a developer such as a toner. The sheet is, for example, a paper or a label paper. The sheet may be any kind of sheet as long as the image processing apparatus 100 can form an image on a surface thereof.

The display 110 is an image displaying device such as a liquid crystal display, an organic EL (Electro Luminescence) display and the like. The display 110 displays various information relating to the image processing apparatus 100.

The control panel 120 includes a plurality of buttons. The control panel 120 receives an operation inputs by a user. The control panel 120 outputs a signal in response to an operation inputs by the user to a controller of the image processing apparatus 100.

The printer section 130 forms an image on the sheet based on image information generated by the image reading section 200 or image information received through a communication path from the outside of the image processing apparatus 100. The printer section 130 forms an image through the following processing, for example. An image forming section of the printer section 130 forms an electrostatic latent image on a photoconductive drum based on the image information. The image forming section of the printer section 130 forms a visible image by attaching the developer to the electrostatic latent image. Toner is exemplified as a concrete example of the developer. A transfer section of the printer section 130 transfers the toner image onto the sheet. A fixing section of the printer section 130 fixes the toner image on the sheet by heating and pressurizing the sheet. The sheet which is subjected to the image formation may be a sheet housed in the sheet housing section 140, or a sheet that is manually fed by a user.

The sheet housing section 140 houses the sheet which is subjected to the image formation by the printer section 130.

The image reading section 200 reads the image information which is a reading object as intensity of light. The image reading section 200 records the read image information. The recorded image information may be transmitted to another information processing apparatus via a network. The recorded image information may be used to form an image on the sheet by the printer section 130.

In the image reading section 200, a platen glass 202 and a platen cover 204 are provided. The platen cover 204 is provided at the upper portion of the image processing apparatus 100 in an openable manner. At a lower part 203 of the platen cover 204, the slackness may occur in a direction of the platen glass 202 due to aged deterioration. In this case, the slackness may approach or contact the platen glass while the platen cover is closed and may be erroneously detected as a sheet in some cases. Arrows A and B shown in FIG. 1 are used in the description of the image reading section 200 described later.

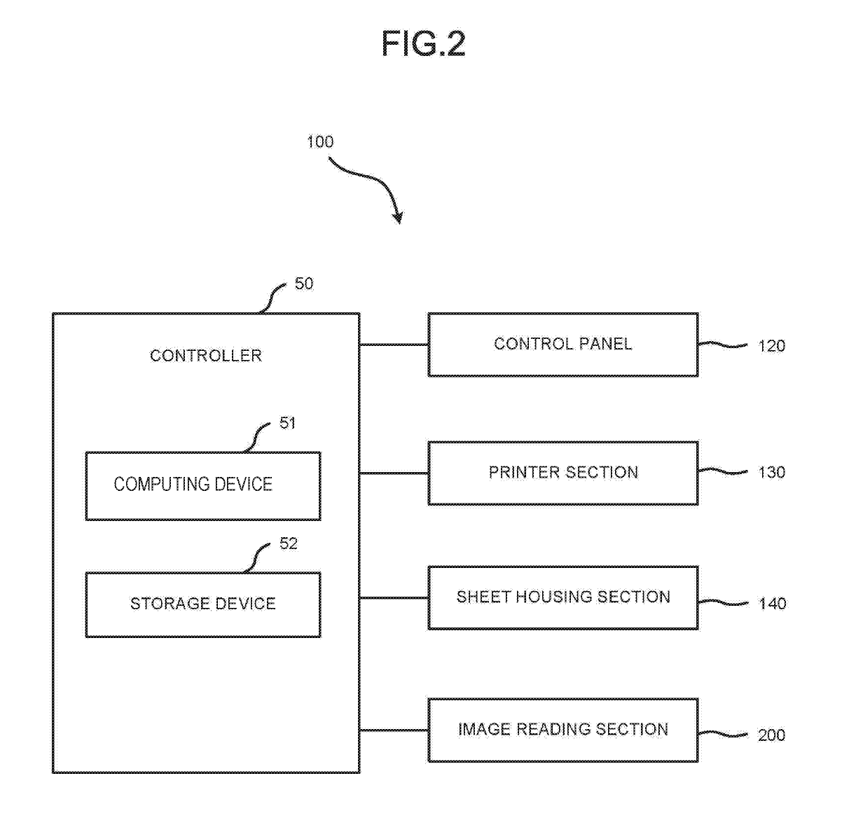

FIG. 2 is a diagram illustrating a control system of the image processing apparatus 100.

In FIG. 2, a controller 50 includes a computing device 51 and a storage device 52. The computing device 51 controls the control panel 120, the printer section 130, the sheet housing section 140, and the image reading section 200 in accordance with various programs stored in the storage device 52.

The computing device 51 is, for example, a CPU (Central Processing Unit), an ASIC (Application Specific Integrated Circuit), or the like. The storage device 52 is a ROM (Read Only Memory), a RAM (Random Access Memory), or the like.

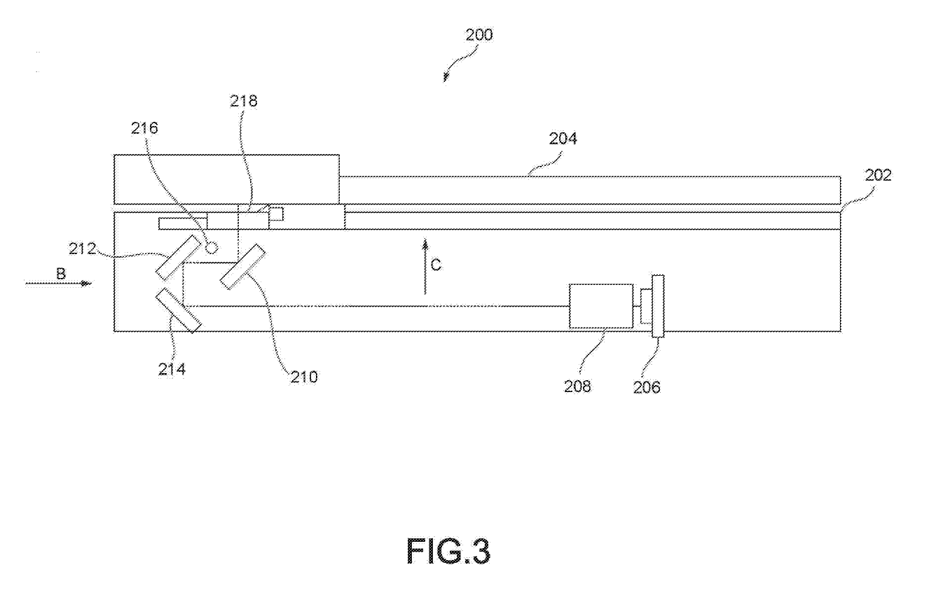

FIG. 3 is a diagram illustrating the configuration of the reading device 200 when viewed from the arrow A direction shown in FIG. 1. In other words, the reading device 200 in FIG. 3 is a diagram viewed from the front side of the image processing apparatus 100. In the following description, the description of the already-mentioned reference numerals is omitted in some cases.

The reading device 200 includes an image sensor 206, an imaging lens 208, a first mirror 210, a second mirror 212, a third mirror 214, a light source 216, and a transparent glass 218.

The light source 216 irradiates an area from which the first mirror 210 receives the reflected light. The image on the sheet right above the transparent glass 218 is imaged by the imaging lens 208 via the first mirror 210, the second mirror 212, and the third mirror 214, and is incident on the image sensor 206. The transparent glass 218 transmits an image on the sheet onto the first mirror 210 at the time of automatic document feed by the reading device 200.

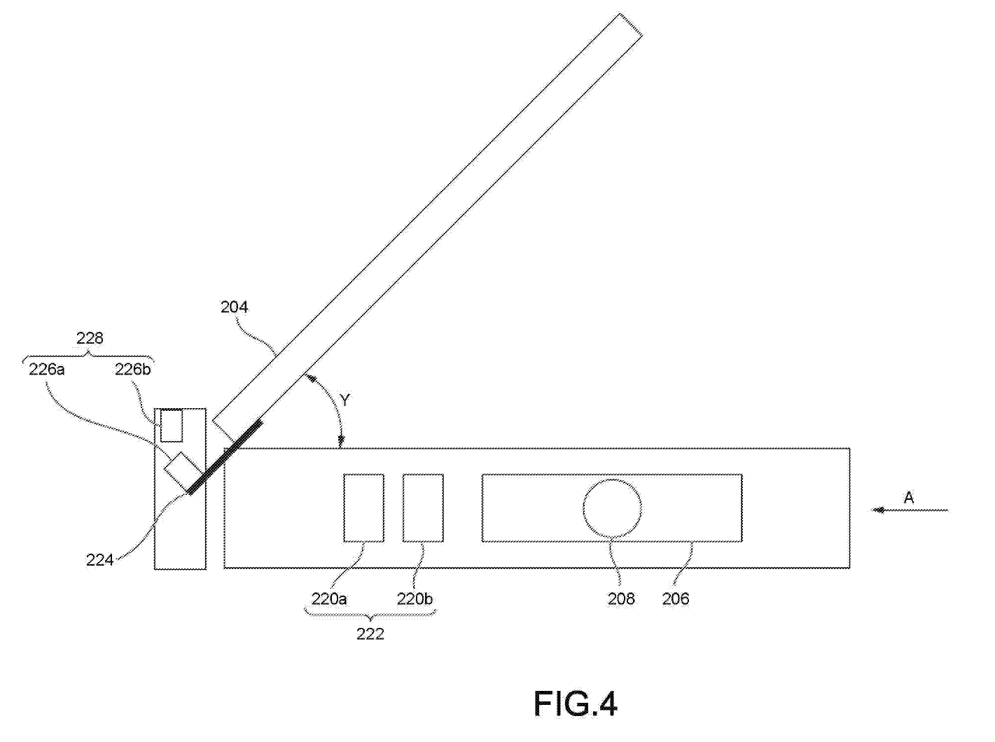

If the platen cover 204 is opened by the user, the light source 216 and the first mirror 210 move in the direction indicated by arrow B to a position indicated by an arrow C while maintaining the positional relationship thereof. As a result, since a line sensor 206 can obtain the image at the position indicated by the arrow C, a size of the sheet in a horizontal scanning direction of the line sensor 206 is obtained. The horizontal scanning direction is parallel to the direction of the arrow B in FIG. 4. For example, if the user places an A4 sheet on the platen glass 202 in such a manner that a longitudinal direction of the sheet is parallel to the horizontal scanning direction, the image processing apparatus 100 can determine that a sheet of A4 or A3 is placed thereon. In the following description, the light source 216 and the first mirror 210 are collectively referred to as a movable mirror in some cases.

FIG. 4 is a diagram illustrating the configuration of the reading device 200 when viewed from an arrow B direction shown in FIG. 1.

The reading device 200 includes a sheet sensor 222, an open/close detection lever 224, and an open/close detection sensor 228. The sheet sensor 222 detects a position of edge of a sheet in a vertical scanning direction. In the present embodiment, for ease of explanation, it is assumed that the sheet sensor 222 is positioned to not detect the A4 sheet but detect the A3 sheet when the sheet is placed at a predetermined position on the platen glass 202. The sheet sensor 222 not only detects the sheet but also detects the platen cover 204. Therefore, if there is no slackness in the platen cover 204, the platen cover 204 is detected if the platen cover 204 is completely or almost closed. If the platen cover 204 has slack, depending on the degree of slackness, the platen cover 204 is detected while the platen cover 204 is closed.

The sheet sensor 222 is composed of two sensors 220a and 220b. In the image processing apparatus 100, the sheet size can be specified by the line sensor 206 and the sheet sensor 222 in the case of a sheet with a standard regular size. For example, the number of candidates of the sheet size can be reduced to A4 or A3 by the line sensor 206, and is specified to either A4 or A3 by the sheet sensor 222.

The open/close detection sensor 228 detects whether or not the opened and closed state is changed to the closed state from the predetermined state. The open/close detection sensor 228 is composed of two members 226a and 226b. The open/close detection sensor 228 detects the opened and closed state by the member 226a moving up and down by the open/close detection lever 224. The opened and closed state is determined by the magnitude of an angle (“Y” shown in FIG. 4) formed by the platen cover 204 and the platen glass 202. In the present embodiment, as an example of the predetermined state, a state is used in which the angle formed by the platen cover 204 and the platen glass 202 is 30 degrees. The open/close detection sensor 228 outputs, for example, high if the formed angle is 30 degrees or less, and outputs low if the formed angle is greater than 30 degrees. In the following description, the “formed angle” indicates an angle Y formed between the platen cover 204 and the platen glass 202.

In the present embodiment, the sheet size is specified at the detection timing of the open/close detection sensor 228. For example, A4 and A3 are specified as follows. First, if the user opens the platen cover 204, the movable mirror moves to the position indicated by the arrow C as described above.

Next, if the user places the sheet on the platen glass 202, the line sensor 206 can determine that the sheet size is A4 or A3. Furthermore, if the sheet size is A3, the sheet is detected by the sheet sensor 222. On the other hand, if the sheet size is A4, no sheet is detected by the sheet sensor 222.

Whether the sheet is detected is determined before the detection timing of the open/close detection sensor 228. However, the sheet placed on the platen glass 202 by the user maybe moved. Therefore, in the present embodiment, the sheet size is specified at the time the user closes the platen cover 204 until the formed angle becomes 30 degrees.

As described above, at the time the user closes the platen cover 204 until the formed angle reaches 30 degrees, in a case in which the sheet size is specified, if the slackness occurs in the platen cover 204, there is a possibility of erroneous detection. The timing chart of the operation according to the embodiment will be specifically described below.

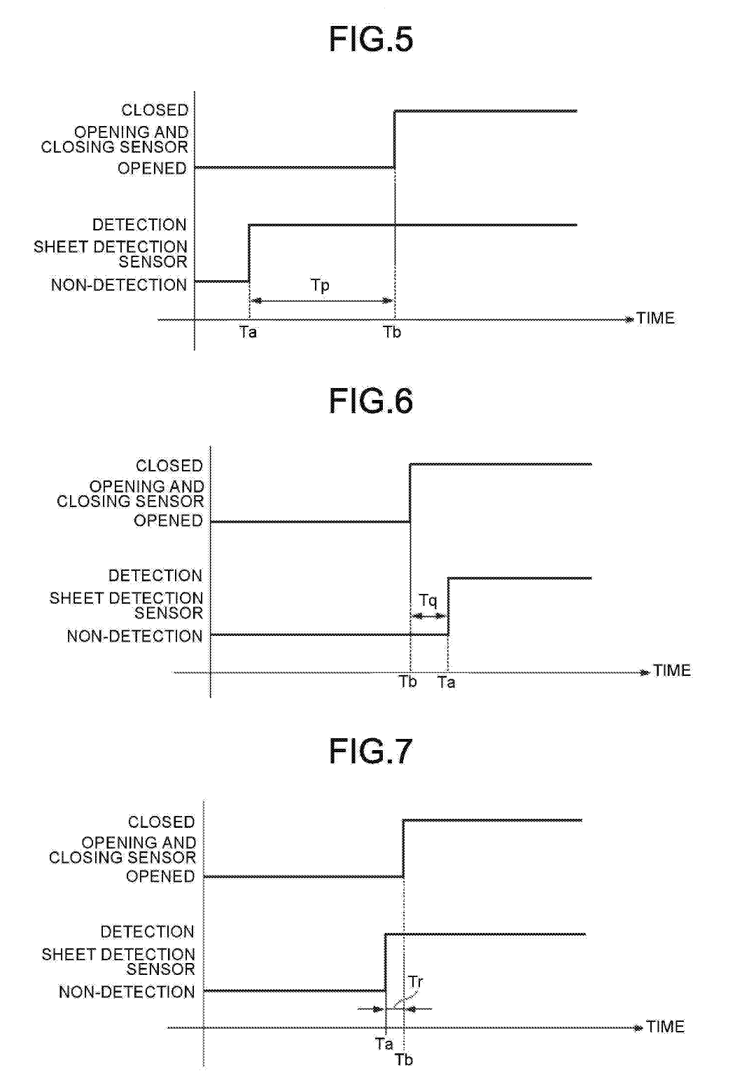

FIGS. 5, 6 and 7 are diagrams illustrating the detection timing of the sheet sensor 222 and the open/close detection sensor 228. In all figures, a timing Ta shows the detection timing of the sheet sensor 222, and a timing Tb shows the detection timing of the open/close detection sensor 228. Therefore, the timing at which the sheet size is specified is the timing Tb.

FIG. 5 is a diagram illustrating an example of each timing in a case in which the user places the sheet on the platen glass 202 and closes the platen cover 204.

The action of the user in FIG. 5 is an action that the user places the sheet on the platen glass 202 and closes the platen cover 204. Accordingly, a detection by the sheet sensor 222 is performed first, and then a detection by the open/close detection sensor 228 is performed. Therefore, the timing Ta comes first, and then the timing Tb comes.

The action that the user places the sheet is an action of placing the sheet on the platen glass 202 first and then positioning the sheet at an appropriate position on the platen glass 202 to perform the image reading process by the reading device 200. The action that the user closes the platen cover 204 is an action of closing the platen cover 204 at a speed at which the sheet is not misaligned due to an influence of the movement of the platen cover 204 when closing the platen cover 204.

Therefore, an elapsed time Tp from the timing Ta to the timing Tb is generally several seconds. Therefore, the elapsed time Tp is the time in units of seconds.

FIGS. 6 and 7 are diagrams illustrating an example of each timing at which the platen cover 204 is closed without placing the sheet on the platen glass 202 by the user. One of the differences between FIGS. 6 and 7 is whether the slackness occurs in the platen cover 204. FIG. 6 shows an example of each timing in the case in which the slackness does not occur in the platen cover 204, and FIG. 7 shows an example of each timing in a case in which the slackness occurs in the platen cover 204.

In both cases of FIGS. 6 and 7, the user does not place the sheet. Therefore, the sheet is not misaligned due to the influence of close of the platen cover 204. Therefore, the platen cover 204 is likely to be closed earlier than that in the case of FIG. 5. Therefore, the elapsed time Tq and Tr from the timing Ta to the timing Tb is generally less than 1 second. Therefore, the elapsed time Tq and Tr is the time in units of millisecond.

In FIG. 6, since the sheet is not placed, the order of the detection timing of the sheet sensor 222 and the opening and closing sensor 228 is opposite to that shown in FIG. 5. Therefore, the timing Tb comes first, and then the timing Ta comes.

On the other hand, in FIG. 7, despite that the sheet is not placed, the order is the same as that in the case in FIG. 5 in which the sheet is placed, i.e., the timing Ta comes first, then timing Tb comes. This is because the slackness of the sheet is detected by the sheet sensor 222 if the platen cover 204 is closed. In this case, since the platen cover 204 is detected during closing, the elapsed time Tr from the timing Ta to the timing Tb is very short.

As described above, the sheet size is specified at the timing Tb. Therefore, if the slackness of the sheet is detected by the sheet sensor 222, an incorrect sheet size is specified.

Therefore, in the present embodiment, control is performed focusing on the case in which the elapsed time Tr described above is extremely short. Specifically, the elapsed time Tr is a time in units of millisecond, but the elapsed time Tp at the time the sheet is placed is the time in units of second as described above. Therefore, it is possible to accurately determine whether the sheet is placed or the slackness is detected depending on the elapsed time. As a result, false detection can be avoided.

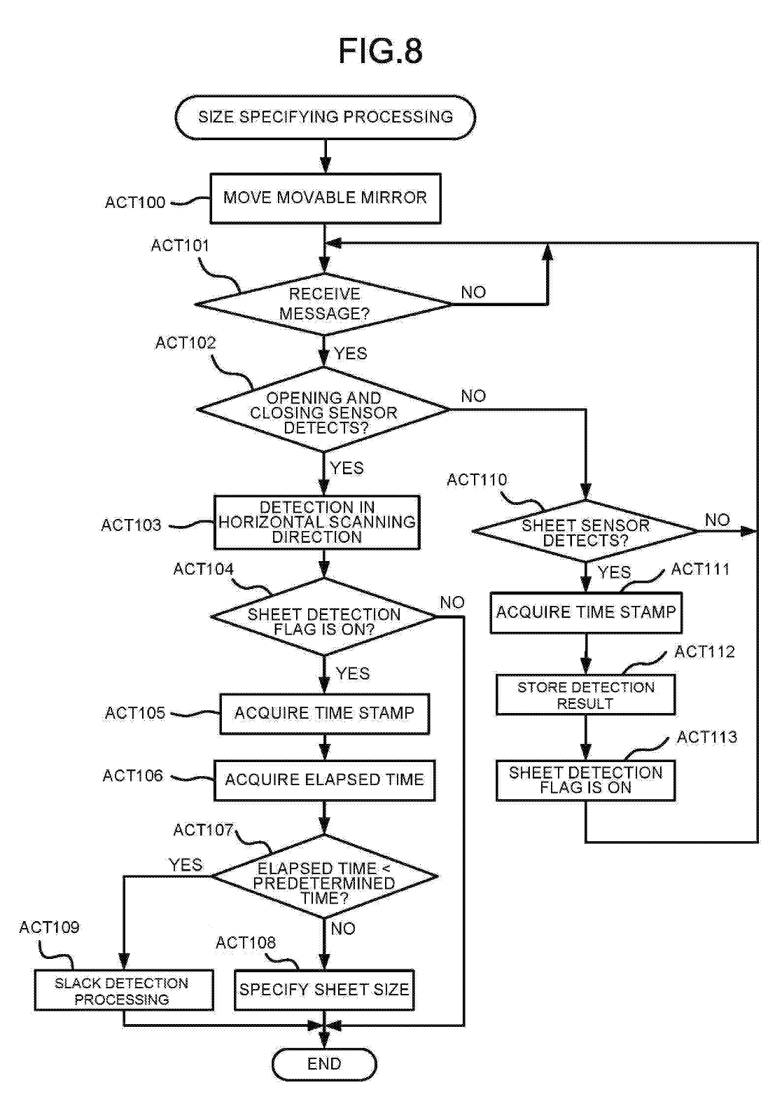

FIG. 8 is a flowchart depicting the flow of the size specifying process. The size specifying process is a process executed when the formed angle becomes larger than 30 degrees from the state in which the platen cover 204 is closed.

Furthermore, if the size specifying process is started, a message is notified from a task of monitoring the open/close detection sensor 228 and a task of monitoring the sheet sensor 222. From the task of monitoring the open/close detection sensor 228, a message indicating that it is detected that the formed angle in the open/close detection sensor 228 reaches 30 degrees is notified. From the task of monitoring the sheet sensor 222, it is notified that the sheet sensor 222 detects any object. From the task of monitoring the sheet sensor 222, a message is notified only if there is a change in a detection result. As the change in the detection result, for example, that an object is detected by the sensor 220a from a state in which nothing is detected, and that the object is also detected by the sensor 220b from a state in which the object is detected only by the sensor 220a are exemplified. Since the sheet sensor 222 can detect the sheet and the slackness, in the following explanation, the sheet and the slackness are collectively referred to as an object.

The controller 50 moves the movable mirror to the position indicated by the arrow C in FIG. 3 (ACT 100). Thereafter, the controller 50 waits for reception of the message from the task of monitoring the open/close detection sensor 228 and the task of monitoring the sheet sensor 222. If the message is received (Yes in ACT 101), the controller 50 proceeds to the processing in ACT 102. The controller 50 determines whether or not it is detected that the formed angle in the open/close detection sensor 228 is 30 degrees (ACT 102). If it is not detected that the formed angle in the open/close detection sensor 222 reaches 30 degrees (No in ACT 102), the controller 50 determines whether or not the sheet sensor 222 detects the object on the platen glass 202 (ACT 110).

If the sheet sensor 222 does not detect the object (No in ACT 110), the flow returns to the processing in ACT 101. If the sheet sensor 222 detects the object (Yes in ACT 110), the controller 50 acquires a time stamp, for example, from the computing device 51 (ACT 111). The time stamp indicates the current time. The controller 50 causes the storage device 52 to store the detection result (ACT 112). Here, the detection result is stored in association with the time stamp. In addition, a plurality of detection results is stored in the storage device 52 so that the detection results detected at the timing earlier than the elapse of the predetermined time since the open/close detection sensor 222 is in the predetermined state can be referred to.

The controller 50 sets a sheet detection flag to ON in the storage device 52 (ACT 113) and returns to the processing in ACT 101. The sheet detection flag indicates ON if the sheet is detected by the sheet sensor 222, and indicates OFF if the sheet is not detected by the sheet sensor 222. Furthermore, the sheet detection flag is initialized to be OFF if the size specifying process is started.

In ACT 102 described above, if it is detected that the formed angle in the open/close detection sensor 222 is 30 degrees (Yes in ACT 102), the controller 50 detects the size in the horizontal scanning direction (ACT 103). As a result, since the size in the horizontal scanning direction can be obtained, the number of candidates for the sheet size can be reduced.

The controller 50 determines whether or not the sheet detection flag is ON (ACT 104). By this processing, the order of performing the detection by the sensors is determined. If the sheet detection flag is OFF (No in ACT 104), the controller 50 ends the present processing. If the sheet detection flag is OFF, since at least the slackness is not detected, erroneous detection due to the slackness does not occur.

If the sheet detection flag is ON (No in ACT 104), the controller 50 acquires a time stamp (ACT 105). The time stamp indicates the current time. The controller 50 acquires the elapsed time from the time stamp acquired in ACT 105 and the time stamp acquired in ACT 112 (ACT 106).

The controller 50 determines whether or not the elapsed time is less than the predetermined time (ACT 107). The predetermined time varies depending on the structure and mass of the platen cover 204, but it is a time of at least less than 1 second which is in units of millisecond.

If the elapsed time is not less than the predetermined time (No in ACT 107), it is determined that the user places the sheet and closes the platen cover 204. Therefore, the controller 50 specifies the sheet size based on the size in the horizontal scanning direction and the detection result of the sheet sensor 222 (ACT 108), and then ends the present processing.

On the other hand, if the elapsed time is less than the predetermined time (Yes in ACT 107), it is determined that the slackness is detected. Accordingly, the controller 50 performs slack detection processing (ACT 109) and ends the present processing.

There is a plurality of processing in the slack detection processing. In accordance with the detection result detected by the sheet sensor 222 at a timing earlier than the elapse of the predetermined time since the formed angle in the opened and closed state of the platen cover 204 becomes 30 degrees, all the processing is a processing of specifying the sheet size.

For example, if the description is made with reference to FIG. 7, the sheet size is specified in accordance with the detection result detected at the timing earlier than the elapse of the predetermined time from the timing Tb. In the example of FIG. 7, the elapsed time from the timing Ta to the timing Tb is less than the predetermined time. The detection results detected earlier than the elapse of the predetermined time from the timing Tb are stored by the processing in ACT 112.

Each slack detection processing will be described below.

First, a first slack detection processing is processing to specify the sheet size if the sheet size is uniquely determined by the detection result detected earlier than the elapse of the predetermined time from the timing Tb.

A second slack detection processing is processing to specify the sheet size having the smallest size if the detection results correspond to a plurality of sheet sizes. For example, if the size detected by the line sensor 206 corresponds to A4 or A3, A4 which is a smaller sheet size is specified.

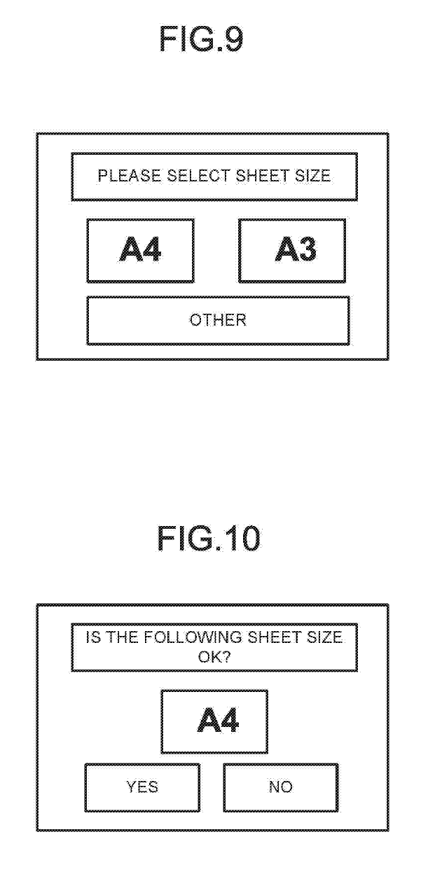

A third slack detection processing is processing to display the corresponding sheet size on the display 110 to enable the user to select the sheet size if the detection results correspond to a plurality of sheet sizes. FIG. 9 is a diagram illustrating an example of a screen displayed on the display 110 for enabling the user to select the sheet size. In the example in FIG. 9, a screen of a case in which the size detected by the line sensor 206 is A4 or A3 is shown.

In the example of the screen in FIG. 9, a A4 button, a A3 button, and “other” button are shown. The A4 button is selected to confirm that the sheet size is A4. The A3 button is selected to confirm that the sheet size is A3.

The “other” button is selected to notify the controller 50 that the sheet size is not A4 or A3. If the “other” button is selected, buttons for selecting other sheet sizes such as B4, B3 and letters (not shown) are displayed. The controller 50 specifies the sheet size selected by the user as the sheet size of the sheet even if the detected sheet size is A4, A3, or another sheet size.

A fourth slack detection processing is processing to display one sheet size among the sheet sizes on the display 110 for the user to confirm if the detection results correspond to a plurality of sheet sizes. FIG. 10 is a diagram illustrating an example of a screen displayed on the display 110 for enabling the user to confirm the sheet size. In the example in FIG. 10, a screen of a case in which the size detected by the line sensor 206 is A4, or A3 and then A4 is shown.

In the screen example in FIG. 10, a “Yes” button and a “No” button are shown. The “Yes” button is selected to confirm that the sheet size is A4. The “No” button is selected to notify the controller 50 that the sheet size is not A4. In the case in which the “Yes” button is selected by the user, the controller 50 specifies the sheet size as A4.

If the “No” button is selected, buttons for selecting other sheet sizes such as B4, B3 (not shown) and a predetermined message corresponding to the other sheet sizes is displayed. The controller 50 specifies the sheet size based on the selection by the user.

The fifth slack detection processing is a processing of updating the predetermined state to a state in which the platen cover 204 is further opened from the opened state in the predetermined state if the elapsed time is less than the predetermined time. In the present embodiment, the state in which the formed angle is 30 degrees is the predetermined state. On the other hand, the fifth slack detection processing is processing to update the predetermined state to a state in which the formed angle is 40 degrees, for example. By doing so, it is possible to detect the predetermined state before the slackness approaches or contacts with the platen glass 202, so that the erroneous detection can be suppressed.

In order to execute the fifth slack detection processing, an angle sensor is attached as the open/close detection sensor 222 to perform detection if the angle becomes predetermined angle. Alternatively, the open/close detection lever 224 may be exchanged with a member that performs detection in the state in which the formed angle is 40 degrees. In a case of exchanging the member, a message for urging the exchange of the member may be displayed for a maintenance person.

As a trigger for updating the predetermined state, for example, a case in which that the elapsed time is less than the predetermined time continues a predetermined number of times or more and a case in which the ratio at which the elapsed time becomes less than the predetermined time is equal to or greater than the predetermined rate.

Among the five slack detection processing described above, the second to fourth processing cannot be performed at the same time, so any one of the above processing may be implemented in the image processing apparatus 100. Alternatively, a plurality of processing may be implemented in the image processing apparatus 100, and which slack detection processing is performed is determined by setting.

As described above, according to the present embodiment, it is possible to avoid the erroneous detection of the platen cover having slack as the sheet.

According to at least one embodiment described above, the image processing apparatus of the embodiment has the platen cover, the detection section, the elapsed time acquisition section, and the specifying section. The platen cover is attached to the upper surface of the platen glass in an openable manner. The detection section is provided at a lower surface side of the platen glass and detects the object on the upper surface of the platen glass. The elapsed time acquisition section acquires elapsed time until the opened and closed state of the platen cover becomes the predetermined state since the object is detected by the detection section in a state in which the opened and closed state of the platen cover becomes the opened state from the predetermined state. The specifying section specifies the sheet size according to the detection result detected by the detection section at a timing before elapse of the predetermined time since the opened and closed state of the platen cover becomes the predetermined state. Thus, it is possible to suppress the erroneous detection of the slack platen cover as the sheet.

Programs for realizing a part or all of the functions of the controller 50 described above are recorded in a computer-readable recording medium. These functions of the controller 50 may be realized by executing the programs recorded in the recording medium by a CPU.

Further, the “computer-readable recording medium” refers to a portable medium and a storage section. The portable medium is a flexible disc, a magneto-optical disk, a ROM, a CD-ROM and the like. The storage section is a hard disk built in the computer system, for example. Furthermore, the “computer-readable recording medium” refers to a medium for dynamically holding the programs for a short time like the network or holding the program for a certain time. The network is the internet. For example, the medium that dynamically holds a program is a communication line in the case of transmitting a program via the communication line. The medium for holding the program for a certain time may be a volatile memory in a computer system serving as a server or a client. The foregoing programs may realize a part of the above-mentioned functions. Further, the foregoing programs may realize the above-mentioned functions with the combination of the programs already recorded in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image processing apparatus, comprising:
a platen cover attached to an upper surface of a platen glass in an openable manner;
a detector at a lower surface side of the platen glass, configured to detect an object on the upper surface of the platen glass; and
a controller configured to determine an elapsed time from when the object is detected by the detector to when the platen cover goes into a predetermined state, and to determine a sheet size of the object according to a first technique if the elapsed time is less than a threshold time and according to a second technique if the elapsed time is greater than the threshold time.

2. The image processing apparatus according to claim 1, further comprising:
a scanner that is movable in a first direction by the controller,
wherein the controller, when determining the sheet size of the object according to the second technique, determines a size of the object in the first direction based on a position of the scanner.

3. The image processing apparatus according to claim 2, wherein the controller, when determining the sheet size of the object according to the second technique, determines a size of the object in a second direction that is perpendicular to the first direction based on an output of the detector.

4. The image processing apparatus according to claim 3, wherein the detector includes a first sensor and a second sensor that is spaced from the first sensor in the second direction.

5. The image processing apparatus according to claim 1, wherein the controller, when determining the sheet size of the object according to the first technique, determines the sheet size of the object as a smallest of sheet sizes detected by the detector.

6. The image processing apparatus according to claim 1, wherein the controller, when determining the sheet size of the object according to the first technique, causes a plurality of sheet sizes detected by the detector to be displayed for selection, and determines the sheet size of the object as one of the displayed sheet sizes that is selected.

7. The image processing apparatus according to claim 1, wherein the controller, when determining the sheet size of the object according to the first technique, causes one of a plurality of sheet sizes detected by the detector to be displayed for confirmation, and determines the sheet size of the object as the displayed sheet size if the displayed sheet size is confirmed.

8. The image processing apparatus according to claim 1, further comprising:
an open/close detection sensor configured to detect whether or not the platen cover forms an angle with the platen glass that is more than a predetermined angle or less than or equal to the predetermined angle, wherein
the platen cover goes into the predetermined state when the open/close detection sensor detects that the platen cover forms an angle with the platen glass that is less than or equal to the predetermined angle.

9. The image processing apparatus according to claim 8, wherein the predetermined angle is 30 degrees.

10. The image processing apparatus according to claim 9, wherein the controller changes the predetermined angle upon determining that the elapsed time is less than the threshold time.

11. A control method in an image processing apparatus including a platen cover attached to an upper surface of a platen glass in an openable manner, and a detector at a lower surface side of the platen glass, configured to detect an object on the upper surface of the platen glass, the method comprising:
determining an elapsed time from when the object is detected by the detector to when the platen cover goes into a predetermined state; and
determining a sheet size of the object according to a first technique if the elapsed time is less than a threshold time and according to a second technique if the elapsed time is greater than the threshold time.

12. The control method according to claim 11, wherein
the image processing apparatus further comprises a scanner that is movable in a first direction by a controller, and
when determining the sheet size of the object according to the second technique, determining a size of the object in the first direction based on a position of the scanner.

13. The control method according to claim 12, wherein when determining the sheet size of the object according to the second technique, determining a size of the object in a second direction that is perpendicular to the first direction based on an output of the detector.

14. The control method according to claim 13, wherein the detector includes a first sensor and a second sensor that is spaced from the first sensor in the second direction.

15. The control method according to claim 11, wherein when determining the sheet size of the object according to the first technique, determining the sheet size of the object as a smallest of sheet sizes detected by the detector.

16. The control method according to claim 11, wherein
when determining the sheet size of the object according to the first technique, causing a plurality of sheet sizes detected by the detector to be displayed for selection, and determining the sheet size of the object as one of the displayed sheet sizes that is selected.

17. The control method according to claim 11, wherein
when determining the sheet size of the object according to the first technique, causing one of a plurality of sheet sizes detected by the detector to be displayed for confirmation, and determining the sheet size of the object as the displayed sheet size if the displayed sheet size is confirmed.

18. The control method according to claim 11, wherein
the image processing apparatus further comprises an open/close detection sensor configured to detect whether or not the platen cover forms an angle with the platen glass that is more than a predetermined angle or less than or equal to the predetermined angle, and
the platen cover goes into the predetermined state when the open/close detection sensor detects that the platen cover forms an angle with the platen glass that is less than or equal to the predetermined angle.

19. The control method according to claim 18, wherein the predetermined angle is 30 degrees.

20. The control method according to claim 19, further comprising:
changing the predetermined angle upon determining that the elapsed time is less than the threshold time.
